(19) United States
(12) Patent Application Publication
(10) Pub. No.: US 2012/0155668 A1
(43) Pub. Date: Jun. 21, 2012

(54) Noise Canceling Earphone and a Driving Circuit

(75) Inventor: Kwok Wah Kam, Hong Kong (CN)

(73) Assignee: ANPAC SEMICONDUCTOR LIMITED, Hong Kong (CN)

(21) Appl. No.: 13/393,453

(22) PCT Filed: Jan. 10, 2011
(86) PCT No.: PCT/CN2011/070130

§ 371 Date: Feb. 29, 2012

(30) Foreign Application Priority Data
Jan. 22, 2010 (HK) 10100744.7

(51) Int. Cl. G10K 11/16

(52) U.S. Cl. 381/71.6

(57) ABSTRACT

The present invention is related to a noise canceling earphone and driving circuit. The driving circuit integrates onto a single chip through system-on-a-chip (SOC) technology, an analog active noise cancellation (ANC) device (203), an audio preamplifier (204), a mixer and a bridge-tied load (BTL) audio amplifier (206). When implementing the technical solution of the present invention, since the SOC technology is adopted, the following beneficial effects can be obtained: (1) Introduction of new noise signals is prevented; (2) Attenuation and distortion of signals is prevented; (3) Layout of the analog ANC device is simplified such that wiring of the left earpiece and the right earpiece is reduced; (4) External components are reduced, thereby reducing cost; (5) The whole SOC circuit with active noise cancellation (ANC) functionality can be mounted within the earpieces of the earphone; and (6) It comes with application design in preventing time division multiple access noise interference in wireless communications using radio waves.

### CROSS-REFERENCE TO RELATED APPLICATIONS

This patent application is a section 371 national phase filing of PCT patent application PCT/CN2011/070130, filed Jan. 10, 2011, which claims priority to a Hong Kong patent application 10100744.7, filed Jan. 22, 2010.

### BACKGROUND OF THE INVENTION

This invention relates to the field of audio equipment, and more particularly to an earphone with active noise cancellation functionality and a driving circuit thereof.

Beginning from the era of cassette players, the market for portable electronic equipments has everlastingly continued to grow. Noise cancellation technology has always been one of the areas of development for portable electronic equipments in order to reduce the amplitude of noise sound waves reaching the eardrums of the users. An active noise cancellation (ANC) technique makes use of electronic means to produce sound waves having the same amplitude as that of the environment noise but being 180 degrees out of phase therewith so that the environment noise is eliminated due to destructive interference.

Since the number of portable audio equipments, such as MP3 players, mobile phones, iPods, and others, is constantly increasing, the requirements for ANC technique continue to advance. This demand drives the ANC technique toward the direction of low cost, small size, low power consumption and ease of mass production.

ANC techniques on the market today are mainly dominated by costly Digital Signal Processing (DSP) and discrete analog means.

FIG. 1 shows a schematic diagram of a conventional earphone. The earphone includes a left earpiece and a right earpiece 101, and a control component 102. The left earpiece and the right earpiece 101 each include a speaker and a microphone for receiving noise. The control component 102 includes a discrete or DSP ANC device and an audio amplifier with a battery. First cables 104 respectively connect the left earpiece and the right earpiece 101 to the control component 102. Second cable 105 connects the control component 102 to a portable audio device via a terminal 103.

However, when using the earphone shown in FIG. 1, the following issues occur:

1. The path from the microphone to the ANC device is too long, making it possible to introduce new noise signals;

2. The path from the audio amplifier in the control component to the speaker is too long, making signals attenuated and distorted;

3. The wirings of the control component and the earpieces that come with the speakers and the microphones are more complex;

4. Sizes of discrete and DSP ANC devices are too large to fit into the earpieces;

5. Discrete and DSP ANC devices require a large number of external components, resulting in too many pins, and a high cost;

6. DSP ANC devices require software integration;

7. DSP and discrete ANC devices have higher power consumption, and easily produce high-frequency interference; and

8. Discrete and DSP ANC devices are adverse for mass production.

### BRIEF SUMMARY OF THE INVENTION

The technical problem to be solved by the present invention is to overcome the above-mentioned shortcomings of existing technology so as to provide a noise canceling earphone driving circuit and capable of integrating the components of a control component onto a single chip.

The technical solution adopted by the present invention to solve the technical problem is: to construct a noise canceling earphone driving circuit, including an analog ANC device that is integrated into a chip through SOC technology, an audio preamplifier, a mixer and a BTL audio amplifier, in which:

The analog ANC device is for receiving and processing a noise signal from the microphones, and for outputting the processed noise signal to a first input terminal of the mixer;

The audio preamplifier is for receiving an audio signal from an audio equipment, for amplifying the audio signal from the audio equipment, and for outputting the amplified audio signal to a second input terminal of the mixer;

The mixer is for mixing the processed noise signal and the amplified audio signal, and for outputting the mixed audio signal to an input terminal of the BTL audio amplifier; and

The BTL audio amplifier is for amplifying the mixed audio signal, and driving the speaker to play the audio signal.

In the noise canceling earphone driving circuit of the present invention, the analog ANC device includes a differential input analog variable gain amplifier and a phase controller, in which:

The differential input variable gain amplifier is for amplifying the noise signal from the microphone; and

The phase controller is for reversing the phase of the amplified noise signal by 180 degrees.

In the noise canceling earphone driving circuit of the present invention, a gain range of the differential input variable gain amplifier is from 3 decibels (dB) to 39 dB.

In the noise canceling earphone driving circuit of the present invention, the audio preamplifier is a differential input audio preamplifier, and the gain range thereof is from 0 dB to 6 dB.

The noise canceling earphone driving circuit of the present invention further includes a mute control module to control muting of the microphone and the audio preamplifier.

The noise canceling earphone driving circuit of the present invention further includes a delay control module for controlling delay time of the noise signal from the microphone.

In the noise canceling earphone driving circuit of the present invention, power supply for the driving circuit is provided by the audio equipment or other external power supply components.

The present invention further constructs a noise canceling earphone, including a left earpiece and a right earpiece to be respectively fixed in left and right ears. The left earpiece and the right earpiece are each provided therein with a speaker and a microphone for receiving noise. Between the microphone and the speaker, there is connected with the aforesaid noise canceling earphone driving circuit.

Implementation of the earphone and the driving circuit thereof according to the present invention, since the SOC technology is used to incorporate the analog ANC device, the audio preamplifier, the mixer and the BTL audio amplifier onto one chip, the following advantages and effects can be obtained:

1. The path from the microphone to the ANC device is shortened, preventing the introduction of new noise signals and interference at radio frequency (RF) high frequencies;

2. The path from the audio amplifier to the speaker is shortened, preventing attenuation and distortion of signals;

3. The wirings of the driving circuit is simplified, reducing connections in the left earpiece and the right earpiece;

4. External components are reduced in number, thereby reducing number of pinouts of the components in the entire driving circuit, and thus reducing cost;

5. Software integration is not needed;

6. Energy consumption is reduced, and it is difficult to produce high-frequency interference;

7. Mass production is facilitated;

8. It can be used on mono audio equipment and stereo audio equipment;

9. If power supply is provided by portable audio and video equipment, the earphones can be plugged directly into the audio and video equipment, and a battery power control unit can be omitted.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 is a schematic diagram of a conventional earphone.

FIG. 2 is a logic structure diagram of a first embodiment of a noise canceling earphone driving circuit.

FIG. 3 is a logic structure diagram of a second embodiment of a noise canceling earphone driving circuit.

FIG. 4 is a circuit diagram of a third embodiment of a noise canceling earphone driving circuit.

FIG. 5A is a structural diagram of the first embodiment of the noise canceling earphone driving circuit.

FIG. 5B is structural diagram of a left earpiece in FIG. 5A.

FIG. 5C is structural diagram of a right earpiece in FIG. 5A, wherein 203—analog ANC device; 204—audio preamplifier; 205—mixer; 206—BTL audio amplifier; 207—speaker; U1—differential input variable gain amplifier; U2—phase controller; U3—differential input audio preamplifier; U4—BTL audio amplifier; U5—gain controller U5; U6—microphone bias generator; U7—band gap; U8—mute controller; U9—controller; M1—mixer; 1—ground terminal; 2—power supply terminal; 3—ANC enabling terminal; 4—left channel audio signal terminal; and 5—right channel audio signal terminal.

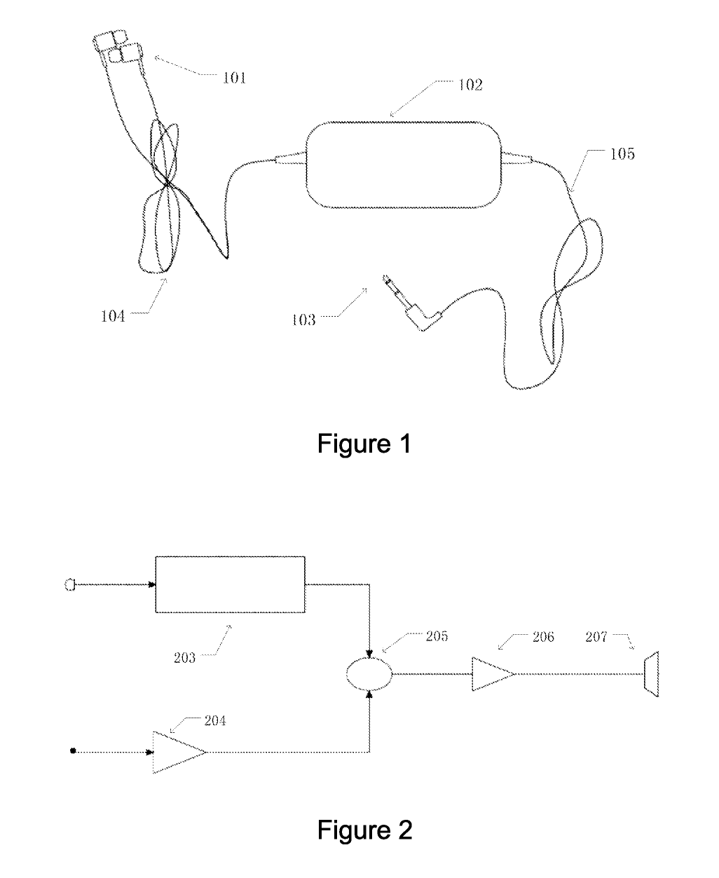

### DETAILED DESCRIPTION OF THE INVENTION

In the logic structure diagram of a first embodiment of a noise canceling earphone driving circuit according to the present invention as shown in FIG. 2, the earphone driving circuit includes an analog active noise cancellation (ANC) device 203, an audio preamplifier 204, a mixer 205, and a bridge-tied load (BTL) audio amplifier 206 all integrated onto a single chip through the system-on-a-chip (SOC) technology. The analog ANC device 203 is connected to a microphone of the earphone for receiving and processing noise signals from the microphone, and outputting the processed noise audio signal to a first input terminal of the mixer 205. The audio preamplifier 204 is connected to an external audio equipment for receiving audio signals from the audio equipment, performing amplification processing on the audio signals, and outputting the amplified audio signals to a second input terminal of the mixer 205. The mixer 205 mixes the processed noise signals and the amplified audio signals, and outputs the mixed audio signals to an input terminal of the BTL audio amplifier 206. The BTL audio amplifier 206 amplifies the mixed audio signals, and drives a speaker 207 to play the audio signals.

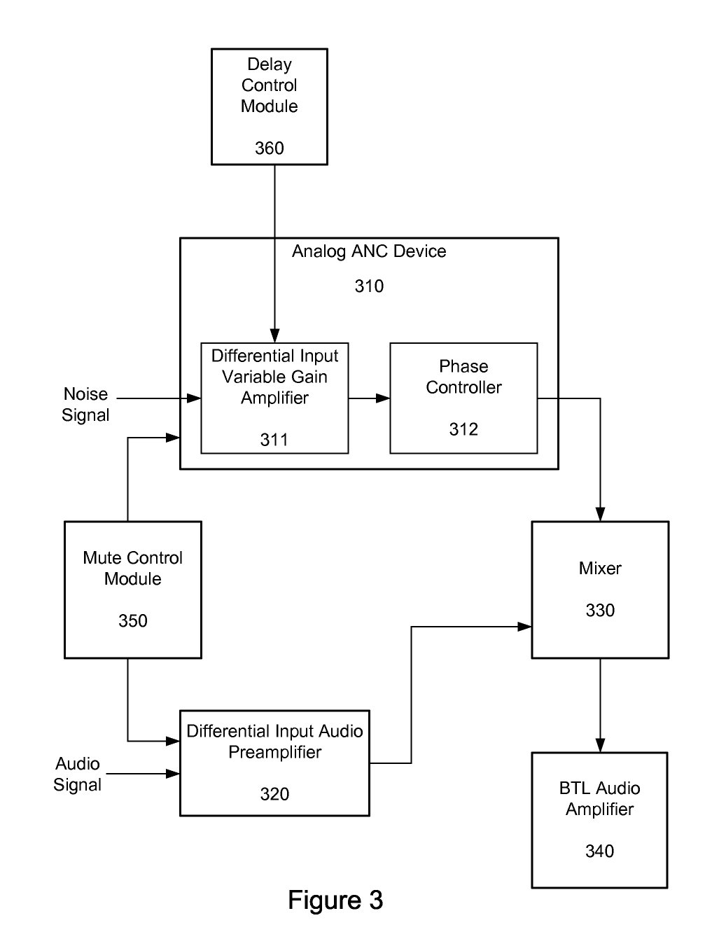

FIG. 3 is a logic structure diagram of a second embodiment of a noise canceling earphone driving circuit according to the present invention. The driving circuit includes an analog ANC device 310, a differential input audio preamplifier 320, a mixer 330, a BTL audio amplifier 340, a microphone and headphone mute control module 350 and a delay control module 360. The analog ANC device 310 includes a differential input variable gain amplifier 311 and a phase controller 312. The differential input variable gain amplifier 311 is connected to the microphone of the earphone for receiving and amplify noise signals from the microphone. The differential input variable gain amplifier 311 has a gain range of from 3 dB to 39 dB, and outputs the amplified signals to the phase controller 312. The phase controller 312 flips the phase of the amplified noise signals by 180 degrees and outputs the same to a first input terminal of the mixer 330. The differential input audio preamplifier 320 is connected to an external audio equipment for receiving audio signals from the audio equipment, and performs amplification processing on the audio signals. The differential input audio preamplifier 320 has a gain range of from 0 dB to 6 dB, and outputs the amplified audio signals to a second input of the mixer 330. The mixer 330 mixes the processed noise signals and the amplified audio signals, and outputs the mixed audio signals to an input terminal of the BTL audio amplifier 340. The BTL audio amplifier 340 amplifies the mixed audio signals and drives a speaker to play the audio signals. The mute control module 350 is used to control muting of the noise signals of the microphone and muting of the differential input audio preamplifier 320. The delay control module 360 is used to control a delay time of the noise signals from the microphone.

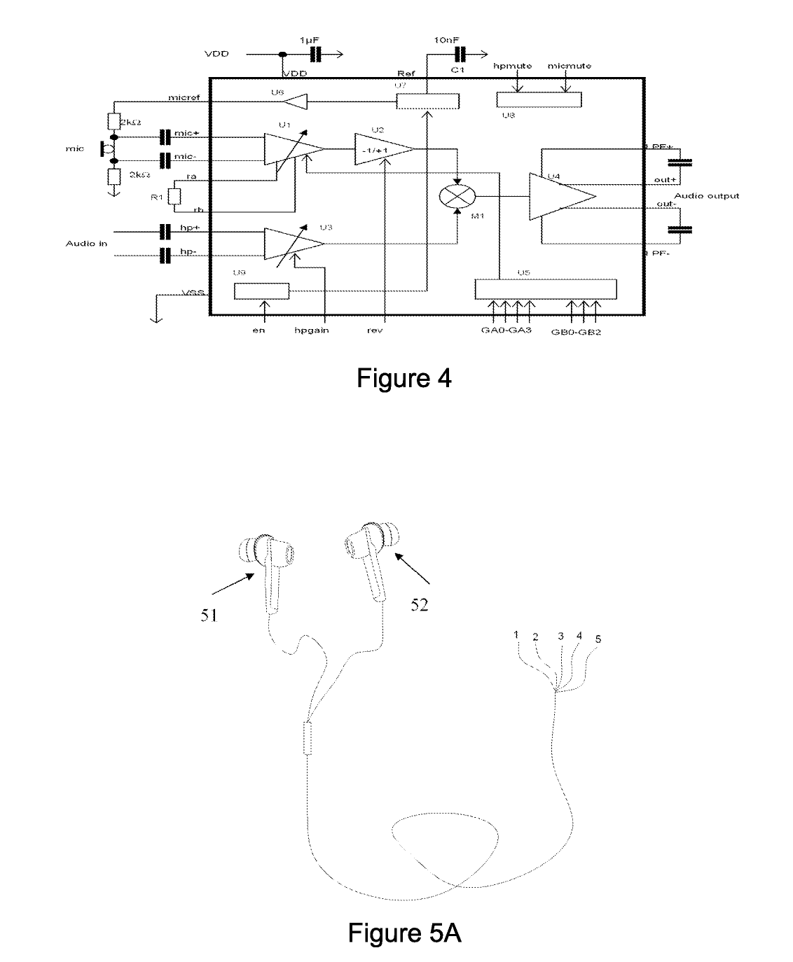

FIG. 4 is a circuit diagram of a third embodiment of a noise canceling earphone driving circuit according to the present invention. In the driving circuit, a microphone positive input terminal and a microphone negative input terminal of the differential input variable gain amplifier U1 are connected to a microphone. A microphone gain adjusting terminal A and a microphone gain adjusting terminal B of the differential input variable gain amplifier U1 are connected through a resistor R1. A gain adjusting terminal of the differential input variable gain amplifier U1 is connected to an output terminal of the gain controller U5. An input terminal of the gain controller U5 is capable of receiving seven gain selections, respectively being GA0-GA3 and GB0-GB2. An output terminal of the differential input variable gain amplifier U1 is connected to an input terminal of the phase controller U2. An output terminal of the phase controller U2 is connected to a first input terminal of the mixer M1. An earphone positive input terminal and an earphone negative input terminal of the differential input audio preamplifier U3 are connected to an audio device, and an output terminal of the same is connected to a second input terminal of the mixer M1. The output terminal of the mixer M1 is connected to an input terminal of the BTL audio amplifier U4. A positive audio output terminal and a negative audio output terminal of the BTL audio amplifier U4 are respectively connected to two input terminals of the audio device or speaker. The controller U9 receives an enable signal, and outputs to the band gap U7. A reference terminal of the band gap U7 is connected to an external capacitor C1, and an output terminal of the same is connected to an input terminal of the microphone bias generator U6. An output terminal of the microphone bias generator U6 is connected to the microphone. Through the adjustment of capacitor C1, the delay time can be adjusted.

The following table lists number, name, function and type of each pin when the driving circuit shown in FIG. 4 is integrated onto a single chip through the SOC technology:

| Pin | Pin | | |
|---|---|---|---|
| Number | Name | Pin functions | Pin type |
| 1 | HPIN+ | Earphone positive input | Analog input |
| 2 | HPIN− | Earphone negative input | Analog input |
| 3 | Micin+ | Microphone positive | Analog input |
| | | input | |
| 4 | Micin− | Microphone Negative | Analog input |
| | | Input | |
| 5 | VSS | Ground | Ground |
| 6 | Mic | Microphone bias | Analog Output |
| | Bias | | |
| 7 | EN | Enable | Digital input |
| 8 | REV | Microphone phase | Digital input |
| | | reverse mode | |
| 9 | HPgain | Earphone gain selection | Digital input |
| 10 | Mic | Microphone mute control | Digital input |
| | mute | | |
| 11 | HP mute | Earphone mute control | Digital input |
| 12 | Test | Test mode | Digital input |
| 13 | Ref | Reference voltage | Analog reference |
| | | coupling | voltage |
| 14 | VSS | Ground | Ground |
| 15 | LPF− | Low-pass filter for | Analog input |
| | | negative output | |
| 16 | Out− | Negative audio output | Analog Output |
| 17 | Out+ | Positive audio output | Analog Output |
| 18 | LPF+ | Low-pass filter for | Analog input |
| | | positive output | |
| 19 | VDD | Power Supply | Voltage supply |
| 20 | GA[0] | Microphone gain | Digital input |
| | | selection A [0] | |
| 21 | GA[1] | Microphone gain | Digital input |
| | | selection A [1] | |
| 22 | GA[2] | Microphone gain | Digital input |
| | | selection A [2] | |
| 23 | GA[3] | Microphone gain | Digital input |
| | | selection A [3] | |
| 24 | RA | Microphone gain | Analog input |
| | | adjustment input A | |
| 25 | RB | Microphone gain | Analog input |
| | | adjustment input B | |
| 26 | GB[0] | Microphone gain | Digital input |
| | | selection B [0] | |
| 27 | GB[1] | Microphone gain | Digital input |
| | | selection B [1] | |
| 28 | GB[2] | Microphone gain | Digital input |
| | | selection B [2] | |

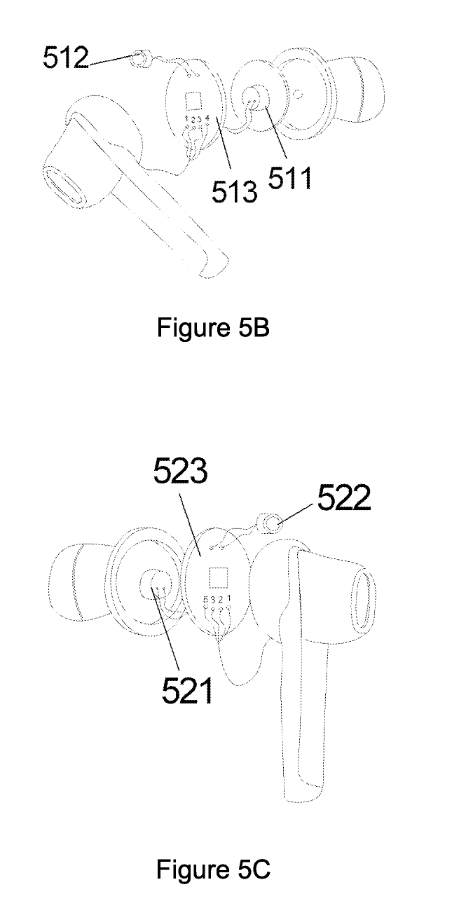

Referring to FIGS. 5A-5C, the noise canceling earphone includes a left earpiece 51 and a right earpiece 52 to be respectively fixed in a left ear and a right ear. The left earpiece 51 is provided therein with a microphone 512 and a speaker 511. The right earpiece 52 is provided therein with a microphone 522 and a speaker 521. Between the microphone 512 and the speaker 511, there is connected a driving board 513 attached with the earphone driving circuit of any one of FIGS. 2-4. Between the microphone 522 and the speaker 521, there is connected a driving board 523 attached with the earphone driving circuit of any one of FIGS. 2-4. In the driving board 513, pin 1 is a ground terminal, pin 2 is a power supply terminal, pin 3 is an ANC enable terminal, pin 4 is a left channel audio signal terminal, and pins 1-4 of the driving board 513 are connected to an audio equipment through connecting lines. In the driving board 523, pin 1 is a ground terminal, pin 2 is a power supply terminal, pin 3 is an ANC enable terminal, pin 5 is a right channel audio signal terminal, and pins 1-3 and 5 of the driving board 523 are connected to the audio equipment through connecting lines. Since the driving circuits on the driving board 513 and the driving board 523 use the SOC integration technology, the driving circuit as a whole can be disposed on a printed circuit board (PCB) of smaller than 12 millimeters (mm) so as to be integrated into the left earpiece 51 and the right earpiece 52. Using the earphone has the following beneficial effects. Since the power supply terminal of the driving circuit is connected to the audio equipment, a battery unit can be omitted. Power supply of the driving circuit can be provided by portable audio and video equipment when the earphone is directly plugged into the audio and video equipment, such that power consumption of the earphone is greatly reduced. The earphone can simultaneously be used with mono audio equipment and stereo audio equipment. With the presence of the ANC enable terminal, a user can choose whether to use the ANC function (this feature is also known as by-pass ANC function). The design of circuit board embedding can reduce wiring of the microphone and the speaker to the shortest possible so as to reduce RF high frequency interference.

Described above are only preferred embodiments of the present invention, and may not be used to limit the present invention. For a technician in this field, the present invention can have a variety of modifications changes and alterations. Any modifications, equivalent replacements, improvements, and so forth, made within the spirit and principle of the present invention should be included in the scope of the claims of the present invention.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A noise canceling earphone driving circuit, characterized by, including an analog ANC device, an audio preamplifier, a mixer and a BTL audio amplifier integrated onto a single chip through the SOC technology, wherein:
the analog ANC device is for receiving and processing noise signals from a microphone, and outputs the processed noise signals to a first input terminal of the mixer;
the audio preamplifier is for receiving audio signals from an audio equipment, amplifies the audio signals from the audio equipment, and outputs the amplified audio signals to a second input terminal of the mixer;
the mixer is for mixing the processed noise signals and the amplified audio signals, and outputs the mixed audio signals to an input terminal of the BTL audio amplifier; and
the BTL audio amplifier is for amplifying the mixed audio signals, and drives a speaker to play the audio signals.

2. The noise canceling earphone driving circuit of claim 1, characterized in that the analog ANC device includes a differential input variable gain amplifier and a phase controller,
wherein the differential input variable gain amplifier is for amplifying the noise signals from the microphone; and
the phase controller is for reversing the phase of the amplified noise signals by 180 degrees.

3. The noise canceling earphone driving circuit of claim 2, characterized in that the differential input variable gain amplifier has a gain range of from 3 decibels to 39 decibels.

4. The noise canceling earphone driving circuit of claim 1, characterized in that the audio preamplifier is a differential input audio preamplifier, and has a gain range of from 0 decibels to 6 decibels.

5. The noise canceling earphone driving circuit of claim 1, characterized in further including a mute control module to control muting of the analog ANC device and the audio preamplifier.

6. The noise canceling earphone driving circuit of claim 1, characterized in further including a delay control module for controlling a delay time of the noise signals from the microphone.

7. The noise canceling earphone driving circuit of claim 1, characterized in that power supply of the driving circuit is provided by the audio equipment.

8. A noise canceling earphone, including a left earpiece and a right earpiece to be fixed respectively on a left ear and a right ear, the left earpiece and the right earpiece being each provided with a speaker and a microphone that receives noise, characterized in that, between the microphone and the speaker, there is connected the noise canceling earphone driving circuit as claimed in claim 1.

9. A noise canceling earphone, including a left earpiece and a right earpiece to be fixed respectively on a left ear and a right ear, the left earpiece and the right earpiece being each provided with a speaker and a microphone that receives noise, characterized in that, between the microphone and the speaker, there is connected the noise canceling earphone driving circuit as claimed in claim 2.

10. A noise canceling earphone, including a left earpiece and a right earpiece to be fixed respectively on a left ear and a right ear, the left earpiece and the right earpiece being each provided with a speaker and a microphone that receives noise, characterized in that, between the microphone and the speaker, there is connected the noise canceling earphone driving circuit as claimed in claim 3.

11. A noise canceling earphone, including a left earpiece and a right earpiece to be fixed respectively on a left ear and a right ear, the left earpiece and the right earpiece being each provided with a speaker and a microphone that receives noise, characterized in that, between the microphone and the speaker, there is connected the noise canceling earphone driving circuit as claimed in claim 4.

12. A noise canceling earphone, including a left earpiece and a right earpiece to be fixed respectively on a left ear and a right ear, the left earpiece and the right earpiece being each provided with a speaker and a microphone that receives noise, characterized in that, between the microphone and the speaker, there is connected the noise canceling earphone driving circuit as claimed in claim 5.

13. A noise canceling earphone, including a left earpiece and a right earpiece to be fixed respectively on a left ear and a right ear, the left earpiece and the right earpiece being each provided with a speaker and a microphone that receives noise, characterized in that, between the microphone and the speaker, there is connected the noise canceling earphone driving circuit as claimed in claim 6.

14. A noise canceling earphone, including a left earpiece and a right earpiece to be fixed respectively on a left ear and a right ear, the left earpiece and the right earpiece being each provided with a speaker and a microphone that receives noise, characterized in that, between the microphone and the speaker, there is connected the noise canceling earphone driving circuit as claimed in claim 7.

15. The noise canceling earphone driving circuit of claim 1, characterized in that the driving circuit design can be implemented on circuit board embedded earphones for effectively reducing time-division multiplexing access noise on wireless applications.

16. The noise canceling earphone driving circuit of claim 1, characterized in that the microphone is of differential input for effectively reducing time-division multiplexing access noise on wireless applications.
